(19) United States
(12) Patent Application Publication
(10) Pub. No.: US 2008/0121787 A1
(43) Pub. Date: May 29, 2008

(54) INPUT APPARATUS AND TOUCH SCREEN USING THE SAME

(76) Inventors: Sun-Hyoung Pyo, Suwon-si (KR); Young-Kwon Yoon, Seoul (KR); Dong-Sung Shin, Suwon-si (KR); Yong-Hwan Choi, Suwon-si (KR); Hyun-Ho Yu, Seoul (KR)

Correspondence Address: CHA & REITER, LLC, 210 ROUTE 4 EAST STE 103, PARAMUS, NJ, 07652, US

(21) Appl. No.: 11/939,581

(22) Filed: Nov. 14, 2007

(30) Foreign Application Priority Data
Nov. 24, 2006 (KR) 2006-116901

(51) Int. Cl. G01J 1/42

(52) U.S. Cl. 250/227.14

(57) ABSTRACT

An input apparatus includes: a light waveguide having a slanted lower surface; a light source for emitting rays in a direction to the light waveguide, the light source facing the lower slanted surface of the light waveguide; and an image sensor, disposed at one side surface of the light waveguide to face the light waveguide, and having a plurality of pixels for detecting rays guided through the light waveguide.

### CLAIM OF PRIORITY

This application claims priority to an application entitled “Input Apparatus And Touch Screen Using The Same,” filed in the Korean Intellectual Property Office on Nov. 24, 2006 and assigned Serial No. 2006-116901, the contents of which are hereby incorporated by reference.

### BACKGROUND OF THE INVENTION

1. Field of the Invention

The present invention relates to an input apparatus, and more particularly, to an input apparatus formed as a touch screen.

2. Description of the Related Art

A touch screen provides a user with picture information to input commands visually and implemented in various apparatuses, such as portable communication terminals or portable digital apparatuses.

Conventional touch screens are classified into a resistance film type touch screen, an ultrasonic wave reflection type touch screen, a contact electrostatic capacity type touch screen, an infrared light reflection type touch screen, etc., and touch screens are generally used in a large size panel because of their big size.

The above-mentioned touch screens have a substrate structure, each having a transparent substance of electric conduction property, such as an ITO, deposited thereon, both surfaces of which face each other.

The touch screens provide a function for inputting information, etc., which are selected by a user, by converting the electric potential differences, which are generated in contacting areas between respective substrates, to coordinates.

The above-mentioned ultrasonic wave reflection type touch screen includes a substrate having the quality of glass, to an end part of which a transmitter for generating sound waves is attached, a reflection member attached to the substrate for reflecting sound waves, and a receiver positioned in the opposite site of the transmitter to receive sound waves. The ultrasonic wave reflection type touch screen reads the coordinates of the charged part in a picture controller when the surface waves of a specific area pressed on the glass substrate become weak, and detects the position of the pressed area.

The contact electrostatic capacity type touch screen converts the change of electrostatic capacity, which is caused by the pressure applied by the user, to a location coordinate. Additionally, the infrared light type touch screen has a similar method as the ultrasonic wave reflection type touch screen.

However, there is some drawbacks in that the conventional type touch screens have weak durability, and it is impossible to input data using non-static materials in the contact electrostatic capacity type touch screen. Further, the infrared light type touch screen has too large a volume and slow response velocity.

### SUMMARY OF THE INVENTION

Accordingly, the present invention has been made to solve the above-mentioned problems occurring in the prior art and provides additional advantages, by providing a touch screen which can be miniaturized, slimmed, and secure the reliability of stable operation.

Still another aspect is that the present invention may be realized in a simple, reliable, and inexpensive implementation.

In accordance with an aspect of the present invention, there is provided an input apparatus, which includes a light waveguide formed in such a manner that a lower surface of the light waveguide is slanted; a light source for emitting rays in a direction to the light waveguide, the light source facing the lower slanted surface of the light waveguide; and an image sensor, positioned in a side surface of the light waveguide to face the light waveguide, and having a plurality of pixels for detecting rays guided through the light waveguide.

### BRIEF DESCRIPTION OF THE DRAWINGS

The above and other aspects, features and advantages of the present invention will be more apparent from the following detailed description taken in conjunction with the accompanying drawings, in which.

FIGS. 1A to 1D are sectional views of an input apparatus according to the exemplary embodiment of the present invention;

FIG. 2D is a perspective view showing a touch screen according to another embodiment of the present invention; and

FIG. 3 is a sectional view of a light waveguide shown in FIG. 2.

### DETAILED DESCRIPTION OF THE EXEMPLARY EMBODIMENT

Hereinafter, exemplary embodiments of the present invention will be described with reference to the accompanying drawings. For the purposes of clarity and simplicity, a detailed description of known functions and configurations incorporated herein will be omitted as it may make the subject matter of the present invention unclear,

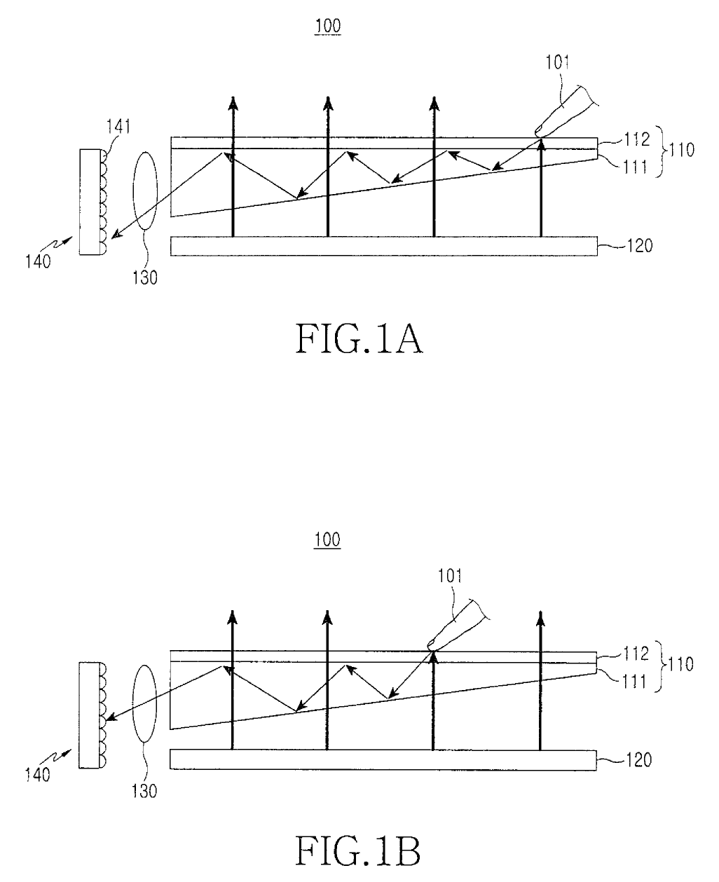

Referring to FIGS. 1A to 1D are sectional views of an input apparatus according to the embodiment of the present invention. The input apparatus 100 shown in FIGS. 1A to 1D includes a light waveguide 110 having a tapered structure or a wedge structure, a light source 120 positioned at a lower part of the light waveguide 110 and emitting rays in a direction towards the light waveguide 110, an image sensor 140 including a plurality of pixels in order to detect rays guided through the one end of the light waveguide 110, a lens 130 interposed between the image sensor 140 and the light waveguide 110.

The light source 120 is positioned at the lower part of the light waveguide 110, and emits rays in a direction to the light waveguide 110. The image sensor 140 is positioned on one side surface of the light waveguide 110 in such a manner of facing thereof to detect rays emitted from the side surface of the light waveguide 110. The image sensor 140 is a type of an array of ray detectors, in which a plurality of ray detectors, as respective pixels, are integrated, and can calculate the position on the light waveguide 110, which is selected by the user, based on whether the rays are detected on corresponding pixels 141. Particularly, the image sensor 140 can use a CCD or a CDMS, etc., in which the pixels 141 are arranged in N number of horizontal lines and M number of vertical lines in order to have a total area of N×M.

The lens 130 is positioned between the side surface of the light waveguide 110 and the image sensor 140, and serves to collect the emitted rays into the corresponding pixel 141.

The light waveguide 11 0 may include a waveguide 111 having a lower surface facing the light source 120, and a protection window 112 attached to an upper surface of the waveguide 111. The side surface (the upper surface of the waveguide 111) to which the protection window 112 is attached has a flat shape, and the lower surface facing the light source 120 of the waveguide 111 has a slanted shape having gradient in a progressive direction of the rays guided by total reflection. Particularly, the lower surface of the waveguide 111 has a structure which is slanted at a predetermined angle and in a perpendicular direction to the progressive direction of the rays emitted from the light source 120, and also has a structure having the thickness which becomes to be gradually thinner from the side surface of the waveguide 111, which faces the image sensor 140, to the other surface.

The protection window 112 may include material having an reflection index lower than that of the waveguide 111 and the waveguide 111 has a lower part exposed to the air so that the protection window 112 and the air provide a function as a clad surrounding the waveguide 111.

The rays emitted from the light source 120 progress perpendicularly to a lengthwise direction of the light waveguide 110, and the rays enter a certain position on the light waveguide 110, which is selected by the user 101. The rays are then reflected by the user 101, guided to the light waveguide 110, and are output to the image sensor 140. Particularly, the light waveguide 110 guides the rays reflected by the user 101 to the image sensor 140 through the total reflection, and the image sensor 140 can detect the incident rays in the corresponding pixels 141.

The rays, which enter the interior of the light waveguide 110 of the flat shape within a critical angle, progress to the interior of the light waveguide 110 from the one surface thereof to the other surface thereof through total reflection. The rays, which enter the light waveguide 110 having a tapered structure or a wedge structure according to the present embodiment, are emitted to the side surface of the light waveguide 110 in different paths, respectively, depending on the angle of the slope of light waveguide 110. Due to the same reason, the rays, which enter the different positions on the light waveguide 110, respectively, are output at emitting angles different from each other, depending on the respective positions from which the rays enter.

Particularly, in the present invention, since one surface of the light waveguide 110 is formed as a structure having a slanted taper or a slanted wedge, the progression paths of reflected rays arc different from each other depending on the respective positions selected by the user 101. Additionally, the image sensor 140 has a configuration in which a plurality of ray detectors is arranged as respective pixels, and detects the rays, which are output in the respective different paths and at the respective different reflection angles depending on the reflection positions, in the corresponding pixels, so as to calculate the position on the light waveguide 110, which is selected by the user.

FIG. 1A to FIG. 1D are views illustrating the position of a ray which is output according to the user's selection. It is shown in FIG. 1A that the ray, which is reflected at a certain position on the waveguide 110, which is furthest from the image sensor 140, is output to the lowest pixel 141 of the image sensor 140. On the other hand, FIG. 1D is a sectional view illustrating a position of a ray in the case that the user selects a certain position on the light waveguide 110, which is nearest to the image sensor 140. It can be known that the ray is output to an upper position, compared with the position in FIGS. 1A to 1C, of the image sensor 140.

Particularly, since the present embodiment includes the light waveguide 110 having the wedge structure or the tapered structure so that the progressive paths of rays reflected by the user are different from each other depending on the positions on the light waveguide 110. Therefore, the emitting angles of rays, which are emitted to the image sensor 140, are different from each other depending on the positions selected by the user, and the pixels 141 of the image sensor 140 for detecting the rays are different from each other depending on them.

Particularly, according to the present embodiment, the rays are output from the light waveguide 110 to the image sensor 140 at the angles which are different from each other, respectively, depending on the positions selected by the user 101 on the light waveguide 110, and the positions of the pixel 141 of the image sensor 140 for detecting rays are also different from each other depending on them.

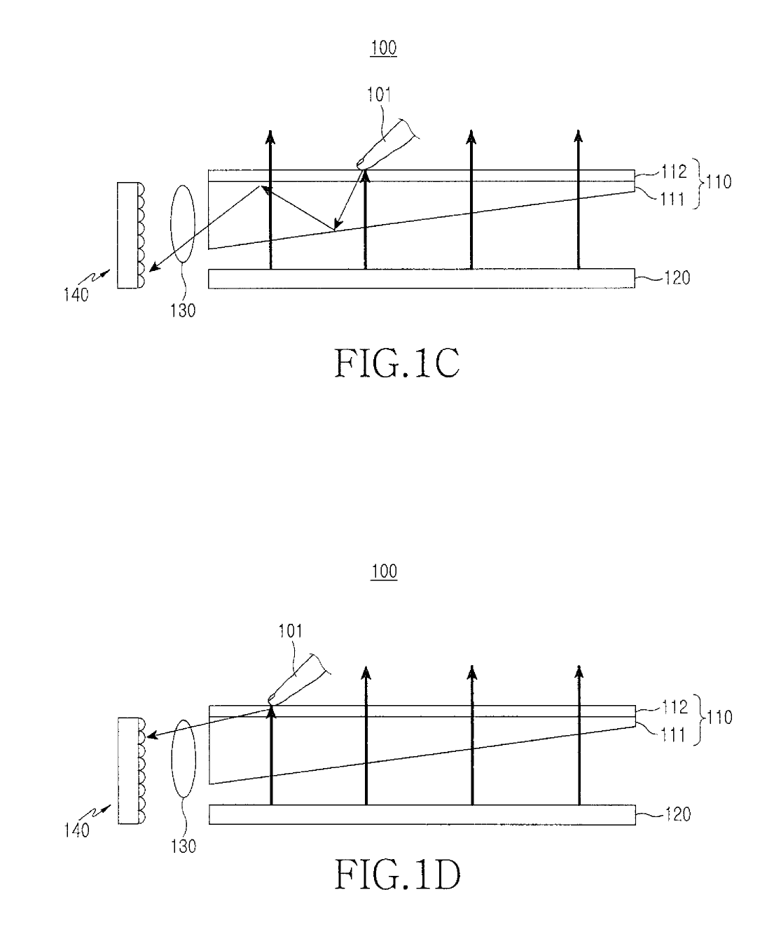

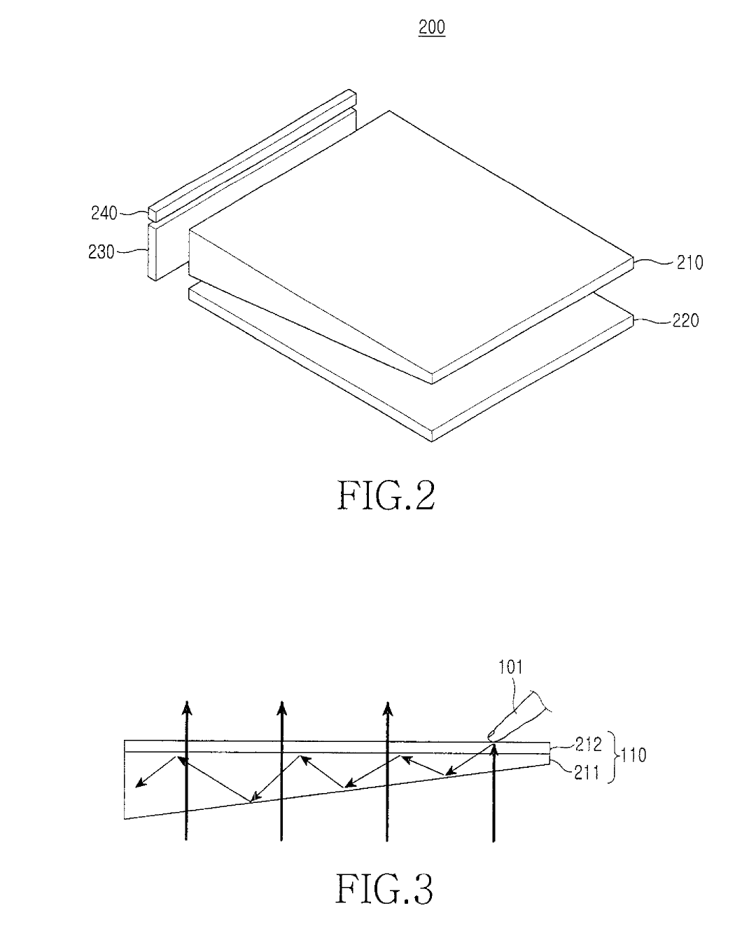

FIG. 2 is a perspective view of the touch screen according to another embodiment of the present invention, FIG. 3 is a sectional view of the light waveguide shown in FIG. 2. FIG. 2 and FIG. 3 show the light waveguide 210 including a waveguide 211 on which a liquid crystal display 212 is disposed, the first light source 220 positioned in a lower part of the light waveguide 210, and a touch screen 220 including the second light source 240 for a background lighting of the liquid crystal display 212.

In the present embodiment, the relation between the light waveguide 210, the first light source 220, and an image sensor 230 is same to one in the embodiment shown in FIG. 1A to FIG. 1D. The embodiment of the present invention includes the liquid crystal display 212 instead of the protection window, and further includes the second light source 240 for the background lighting of the liquid crystal display 212. The description of the repeated configuration of the present embodiment, compared with the configuration shown in FIG. 1A of the present invention, hereinafter, will be omitted to avoid redundancy.

The present invention has a comparatively simple configuration, can be implemented as an input apparatus in a touch screen way, miniaturize products, and minimize the manufacturing cost of the products. Furthermore, the present invention has a simple configuration to easily secure reliability (durability and resistance to physical shock).

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An input apparatus comprising:
a light waveguide having a slanted lower surface;
a light source for emitting rays in a direction towards the light waveguide, the light source facing the slanted lower surface of the light waveguide; and
an image sensor disposed at one side surface of the light waveguide to face the light waveguide and having a plurality of pixels for detecting rays guided through the light waveguide.

2. The input apparatus as claimed in claim 1, wherein the light waveguide comprises a waveguide having a lower surface slanted from one side of the waveguide to the other side of the waveguide, and a protection window or a liquid crystal display disposed on an upper surface of the waveguide.

3. The input apparatus as claimed in claim 2, wherein the protection window includes material having an reflection index lower than that the light waveguide.

4. The input apparatus as claimed in claim 2, wherein a lower part of the light waveguide is exposed to air so that the protection window and the air functions as a clad surrounding the waveguide.

5. The input apparatus as claimed in claim 1, further comprising a lens disposed between the image sensor and the light waveguide.

6. The input apparatus as claimed in claim 1, wherein the image sensor having a plurality of ray detectors to calculate the position on the light waveguide, which is selected by a user, based on whether the rays are detected on corresponding ray detectors.

7. The input apparatus as claimed in claim 6, wherein the plurality of ray detectors comprises a plurality of pixels.

8. The input apparatus as claimed in claim 7, wherein the lens serves to collect the first rays into the corresponding pixel.

9. A touch screen including the input apparatus claimed in claim 1.

10. A touch screen comprising:
a light waveguide having a tapered thickness and guiding, first rays;
an image sensor having a plurality of pixels for detecting the first rays guided through the light waveguide; and
a liquid crystal display disposed at an upper surface of the light waveguide.

11. The touch screen as claimed in claim 10, further comprising a second light source for emitting second rays to a side surface of the light waveguide, the rays being used for reproducing pictures.
